(19) United States
(12) Patent Application Publication
(10) Pub. No.: US 2020/0039443 A1
(43) Pub. Date: Feb. 6, 2020

(54) ROLLING MOLDING ROOF BOX STRUCTURE

(71) Applicant: FORMOSA SAINT JOSE CORPORATION, TAIPEI (TW)

(72) Inventor: Ming-Shun Yang, Taipei (TW)

(73) Assignee: FORMOSA SAINT JOSE CORP., Taipei (TW)

(21) Appl. No.: 16/315,646

(22) PCT Filed: Apr. 17, 2018
(86) PCT No.: PCT/CN2018/083255

§ 371 Date: Jan. 6, 2019

(30) Foreign Application Priority Data
Apr. 24, 2017 (CN) 201710271332.7

(51) Int. Cl. B60R 9/055

(52) U.S. Cl. CPC B60R 9/055

(57) ABSTRACT

The present invention discloses a rolling molding roof box structure. The rolling molding roof box includes a roof box formed by rolling molding and at least one roof box door. With the implementation of the present invention, the rolling molding roof box is firmly constructed and waterproof without combining portion; no fastening parts required with budget saving advantage; light weight for easy operating even by a single person; and capable of preventing separation by wind when driving to ensure the safety of driving of a vehicle with a roof box on car top.

### BACKGROUND OF THE INVENTION

### 1. Technical Field

The present invention relates to a roof box structure, and more particularly, to a roof box structure formed by rolling molding.

### 2. Description of Related Art

As cars are in wide use nowadays, consumers' demand for roof box is continuously increasing. However, as a variety of roof boxes being made, only the outlooks or decoration being changed, the basic structure nature of roof boxes is still essentially a combination of a top cover and a lower base.

That is to say, known existing roof boxes in the market or being used are basically a top cover combined to a lower base with several fastener parts, that results in the enormously weight and thickness requiring for ensuring the strength of the structure, the susceptibility of separation or damage by wind when driving, or the susceptibility of the contents of roof boxes being damaged by water leakage.

What is more, the weight of the known roof boxes is so high that it being very much difficult or hardly to access by one single person, either to instore or to operate on the car top.

Accordingly, it is imperative to provide a production method of rolling molding roof box or a roof box structure which is capable of being effectively formed by light material without a windward joint portion, strong structural force and water proof, easily operable by one single person in instore or remove, and most importantly, to prevent the roof box from been separated by wind when driving, and thus meets automakers' progress and expectations in terms of low costs, high efficiency and safety.

### SUMMARY OF THE INVENTION

The present invention discloses a rolling molding roof box structure. The rolling molding roof box structure includes a roof box formed with rolling molding and at least one roof box door. With the implementation of the present invention, the rolling molding roof box is firmly constructed and waterproof without combining portion; no fastening parts required with budget saving advantage; light weight for easy operating even by a single person; and capable of preventing separation by wind when driving to ensure the safety of driving of a vehicle with a roof box on car top.

The present invention provides a rolling molding roof box structure, comprising: a roof box formed by a production method of rolling molding, wherein at least one access gate is formed by cutting on at least one side of the roof box; and at least one roof box door, wherein a roof box door being openably combined and attached to each access gate.

Implementation of the present invention at least involves the following inventive steps:

1. Being without a windward joint portion, strong structural force and water proof.

2. Being not a top cover+lower base structure, preventing the roof box from been separated by wind when driving to ensure the safety of driving of a vehicle with the roof box on car top.

3. Strong structural force being effectively formed by light material, operable by only one single person.

4. Requiring no fastening parts.

5. Reducing enormously the production cost and the material cost.

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

### BRIEF DESCRIPTION OF THE SEVERAL VIEWS OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is a schematic three-dimensional view of a rolling molding roof box according to an embodiment of the present invention.

FIG. 2 is a schematic three-dimensional view of a rolling molding roof box further comprises at least one water guiding groove according to an embodiment of the present invention.

FIG. 3 is a schematic three-dimensional view of a rolling molding roof box with the access gate being sealed by the roof box door according to an embodiment of the present invention.

FIG. 4 is a schematic three-dimensional view of a rolling molding roof box with a link lock according to an embodiment of the present invention.

FIG. 5 is a schematic three-dimensional view of a rolling molding roof box with the roof box door being locked on roof box over the access gate with a link lock according to an embodiment of the present invention.

FIG. 6 is a schematic three-dimensional view of a roof box door being with an air pump and being connected to a link lock according to an embodiment of the present invention.

FIG. 7A is a schematic three-dimensional view of a rolling molding roof box with the roof box door being a top opening roof box door according to an embodiment of the present invention.

FIG. 7B is a schematic three-dimensional view of a rolling molding roof box with the roof box door being an open below roof box door according to an embodiment of the present invention.

FIG. 7C is a schematic three-dimensional view of a rolling molding roof box with the roof box door being an open sidewise roof box door according to an embodiment of the present invention.

FIG. 8 is a schematic three-dimensional view of a rolling molding roof box with at least one reinforcement rib being formed on the bottom side of the roof box according to an embodiment of the present invention.

### DETAILED DESCRIPTION OF THE EMBODIMENTS OF THE INVENTION

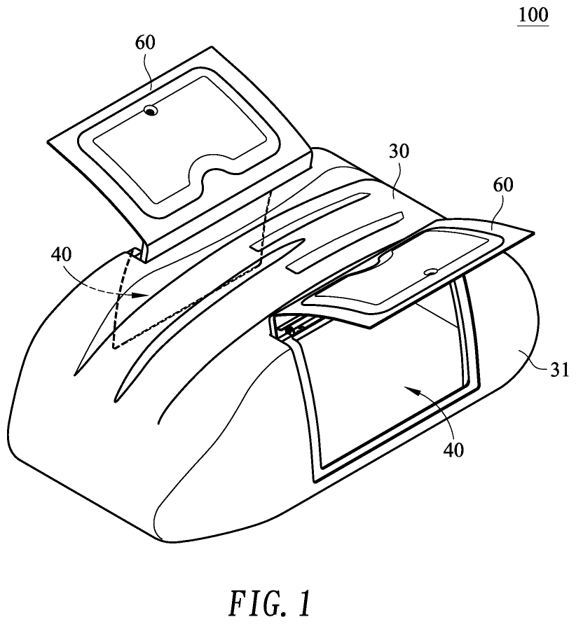

Please refer to FIG. 1, in an embodiment of the present invention, a rolling molding roof box structure 100 made of plastic material, comprising: a roof box 30 formed by a production method of rolling molding and at least one roof box door 60.

The production method of rolling molding is to use a three-dimensional hollow mold for filling material inside and heating the material to evenly distributed on the inner surface, then fetch the material after it is cooled and shaped with the shape of the mold. Thus, the product of the production method of rolling molding is a one piece object and having the shape of the inner surface of the mold.

As shown in FIG. 1, one access gate 40 is formed on at least one side 31 of the roof box 30, wherein a roof box door 60 is fixed to the side 31 with the access gate 40 and covering the access gate 40.

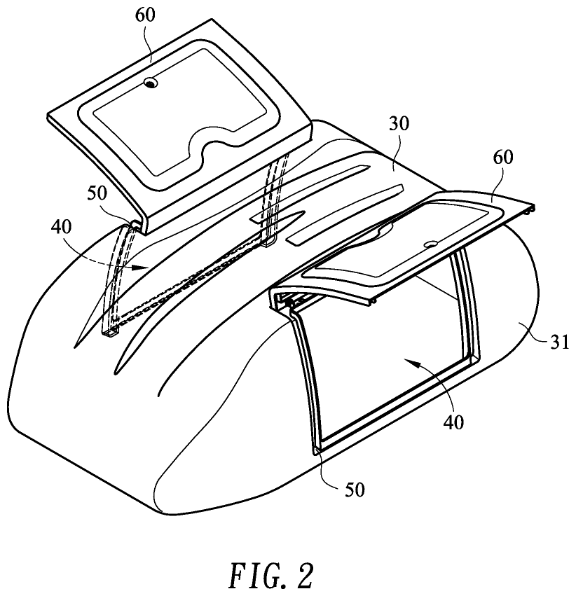

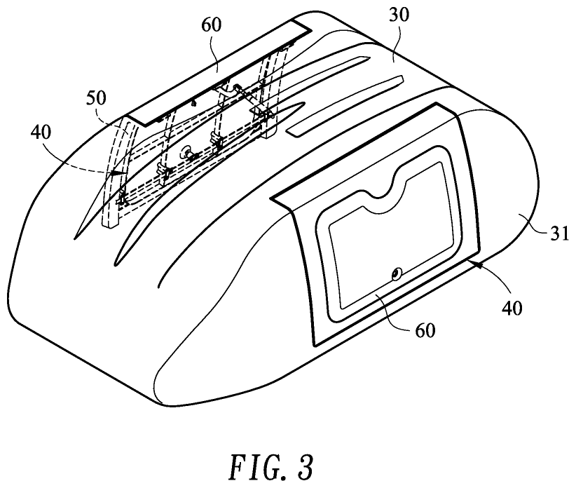

As shown in FIG. 2 and FIG. 3, at least one water guiding groove 50 can be formed on the roof box 30 surface around the access gate 40, the water guiding groove 50 having the effect of water preventing, water guiding, and enforcing the structural force of the roof box, wherein a part of the roof box door 60 can be tightly inserted into the water guiding groove 50 when covering the access gate 40 making the roof box 30 perfectly water tight.

While in applications, the aforesaid plastic material can be High Density Polyethylene (HDPE), Poly Carbonate (PC), Polypropylene (PP) or other light and enduring plastic materials. Besides, the shape of the rolling molding roof box structure 100 can be changed by using different shapes of blow mold. With the property of being one piece with no seam, the rolling molding roof box structure 100 is also light in weight, having strong structural force, being completely water proof, requiring no fastening parts and therefore reducing enormously the production cost and the material cost.

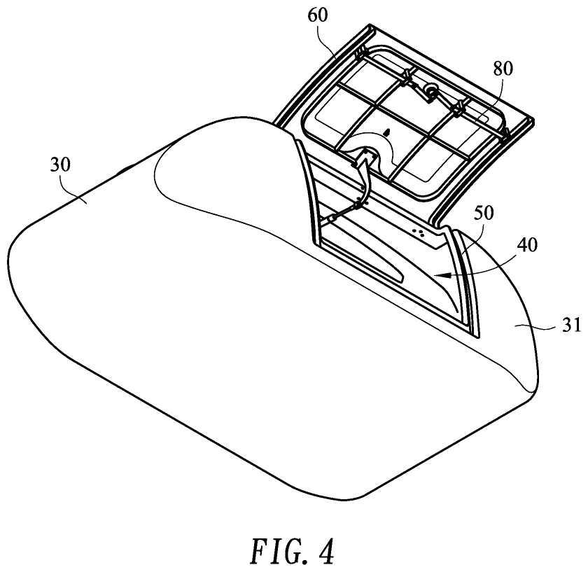

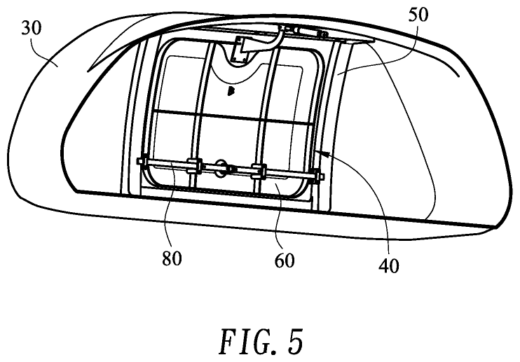

Moreover, as shown in FIG. 4 and FIG. 5, a link lock 80 can be formed on or fixed to the roof box door 60, wherein the roof box door 60 can be locked on roof box 30 over the access gate 40 with the link lock 80.

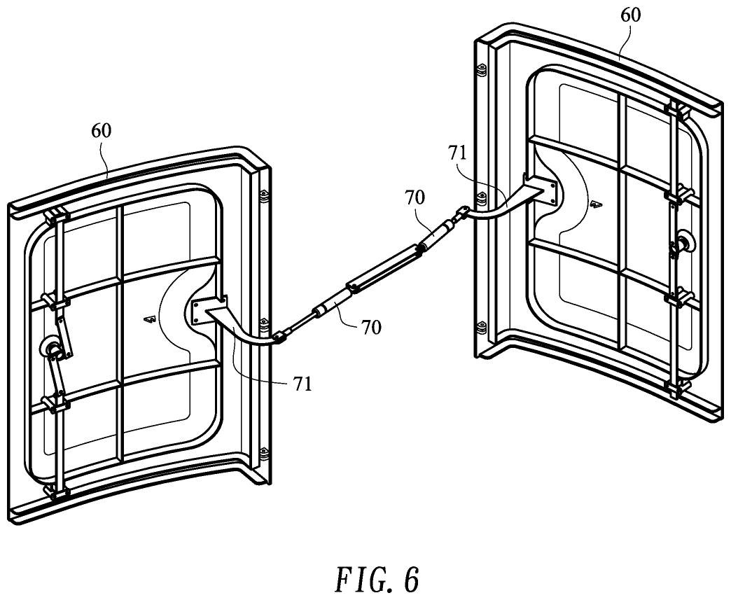

As shown in FIG. 6, an air pump 70 can be combined or fixed to the roof box door 60 together with the link lock 80, the roof box door 60 can then be smoothly opened or closed by using the air pressure of the air pump 70.

As also shown in FIG. 6, an air pump 70 is connected to the roof box doors 60 on either side of the roof box 30, with these two air pumps 70 connected with a link rod 71 that is fixed to the roof box 30, the roof box doors 60 can be further stable in the right position.

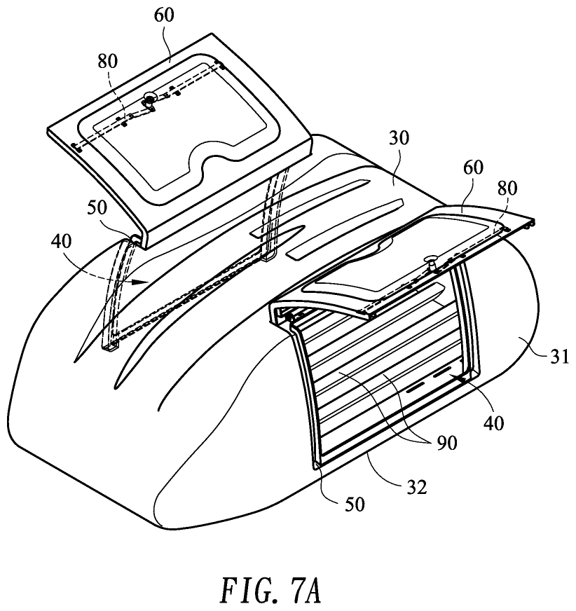

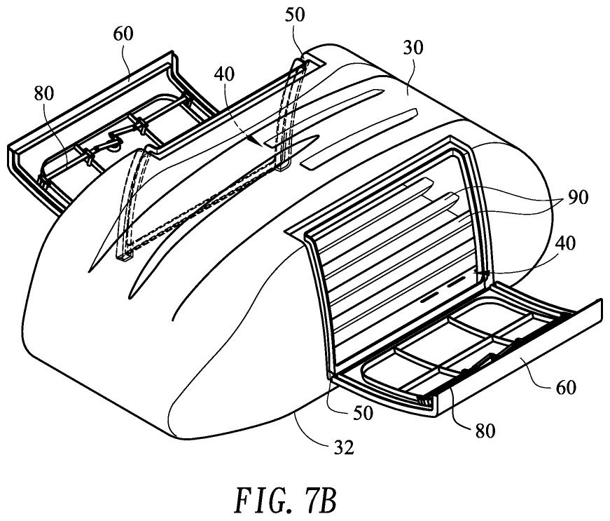

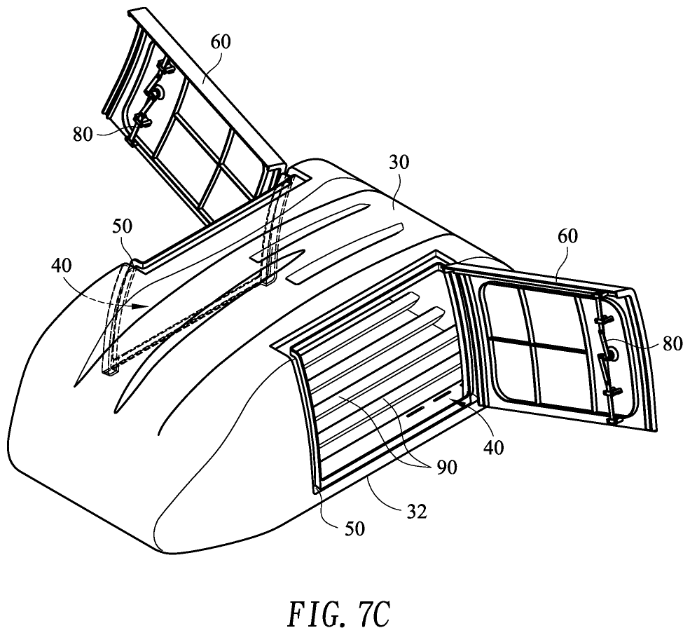

And as shown in FIG. 7A, FIG. 7B and FIG. 7C, the type of the roof box door 60 can be a top opening door, a below opening door or a sidewise opening door.

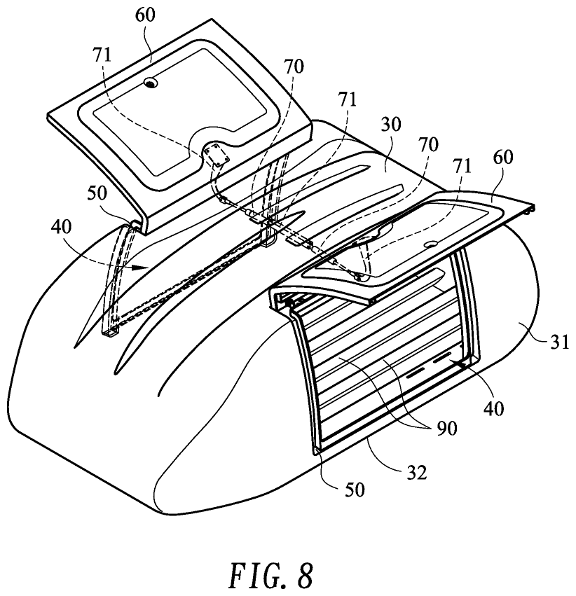

As also shown in FIG. 7A, FIG. 7B, FIG. 7C and FIG. 8, to greatly improve the structural force and the endurance when high speed driving, at least one reinforcement rib 90 can be formed on the bottom side 32 of the roof box. 30.

In conclusion, as indicated by the description of the aforesaid embodiments, the rolling molding roof box structure 100, features firmly constructed and waterproof without combining portion; no fastening parts required with budget saving advantage; light weight for easy operating even by a single person; and capable of preventing separation to ensure the safety of driving of a vehicle with the molding roof box structure 100 on car top.

The embodiments described above are intended only to demonstrate the technical concept and features of the present invention to enable a person skilled in the art to understand and implement the contents disclosed herein. It is understood that the disclosed embodiments are not to limit the scope of the present invention. Therefore, all equivalent changes or modifications based on the concept of the present invention should be encompassed by the appended claims.

What is claimed is:

1. A rolling molding roof box structure, comprising:
a roof box formed by rolling molding, wherein at least one access gate is formed by cutting on at least one side of the roof box; and
at least one roof box door, being openably combined and attached to the roof box and covering the access gate.

2. The rolling molding roof box structure of claim 1, wherein at least one water guiding groove being formed on the roof box surface around the access gate.

3. The rolling molding roof box structure of claim 2, wherein a part of the roof box door being tightly inserted into the water guiding groove when covering the access gate.

4. The rolling molding roof box structure of claim 1, wherein the roof box door being locked on the roof box over the access gate with a link lock.

5. The rolling molding roof box structure of claim 1, wherein an air pump being connected to the roof box door.

6. The rolling molding roof box structure of claim 4, wherein an air pump being connected to the roof box door.

7. The rolling molding roof box structure of claim 1, wherein at least one reinforcement rib being formed on the bottom side of the rolling molding roof box.
